(19) United States
(12) Patent Application Publication
(10) Pub. No.: US 2012/0110298 A1
(43) Pub. Date: May 3, 2012

(54) MEMORY ACCESS CONTROL DEVICE AND COMPUTER

(75) Inventor: Shuhsaku Matsuse, Kusatsu-Shi (JP)

(73) Assignee: International Business Machines Corporation, Armonk, NY (US)

(21) Appl. No.: 13/287,298

(22) Filed: Nov. 2, 2011

(30) Foreign Application Priority Data
Nov. 2, 2010 (JP) JP2010246614
Nov. 2, 2010 (JP) JP2011070106

(51) Int. Cl. G06F 12/10

(52) U.S. Cl. 711/206; 711/E12.058

(57) ABSTRACT

To virtualize a system without having to incorporate a special mechanism into software and with increases in overhead suppressed, by controlling memory accesses made by processors using hardware.

A device controls memory accesses made by processors and includes multiple address tables that correspond to multiple operating systems (OSs) run by the processors and each translate the logical address of the destination of a memory access made by one of the processors into a physical address in a memory or memory; and a table selection unit that, when one of the processors makes a memory access, obtains identification information of the processor and selects an address table corresponding to an OS run by the processor identified by the identification information from among the address tables as an address table that performs address translation with respect to the memory access.

### FIELD OF THE INVENTION

Embodiments of the present invention relate to a device that virtualizes a system by controlling memory accesses and a computer including the device.

### BACKGROUND

In computer architecture, it has been practiced to create a software operating environment using virtual hardware obtained by virtualizing processors, memory, and the like, so that multiple software programs such as operating systems (OSs) can be run. This type of virtualization technology has been achieved by one of a method called host OS type and a method called hypervisor type. (For example, see Patent Literature 1)

FIG. 8 is a diagram showing the concept of a host OS-type virtualization method.

As shown in FIG. 8, a single host OS 811 runs on hardware 810 in a host OS-type system. On the host OS 811, its tasks 812 are executed and a guest OS 814 is run through a virtual machine monitor 813. On the guest OS 814, its tasks 815 are executed. That is, in the host OS-type system, one of the installed OSs acts as the host OS 811 and provides an operating environment for the other OS (guest OS 814). While the single guest OS 814 is shown in the diagram, multiple guest OSs 814 may be installed together with corresponding virtual machine monitors 813.

FIG. 9 is a diagram showing the concept of a hypervisor-type virtualization method.

As shown in FIG. 9, a hypervisor 911 runs on hardware 910 in a hypervisor-type system. Multiple guest systems (OSs and tasks executed on the OSs) 912 run on the hypervisor 911.

A function for virtualizing a system has been provided by software thus far. That is, virtual hardware for running a guest OS has been achieved using the above-mentioned host OS or hypervisor function. For this reason, there has been a need to incorporate a special mechanism for virtualization into installed software.

For example, in host OS-type systems, the host OS runs even when the guest OS runs. This disadvantageously increases the load imposed on the hardware, increasing the overhead. Further, special software for running the guest OS, such as a virtual machine monitor, is needed.

In hypervisor-type systems, a hypervisor must be formed in a manner corresponding to installed hardware and an OS that runs on the hypervisor. For this reason, when the configuration of the hardware or the type of the OS used is changed, a hypervisor corresponding to the changed hardware or OS must be created. This makes it difficult to construct a flexible system, whose configuration is easily changed.

Further, hypervisor-type systems are classified into so-called para-virtualization type and full-virtualization type. In para-virtualization type, the guest OS must be adapted to the hypervisor. That is, the guest OS must be designed or modified so that it can use a virtual environment provided by the hypervisor.

On the other hand, in full-virtualization type, there is no need to make a modification or the like to the guest OS. However, the hypervisor must support the operation of the guest OS in the virtual environment, thereby disadvantageously increasing the overhead as in host OS-type.

Accordingly, it is an object of the present invention to virtualize a system without having to incorporate a special mechanism into software and with increases in overhead suppressed, by controlling memory accesses made by processors using hardware.

To accomplish the above-mentioned object, embodiments herein disclose a device to control memory accesses made by multiple processors. The device includes multiple address translation units that correspond to multiple operating systems (OSs) run by the processors and each translate the logical address of the destination of a memory access made by one of the processors into a physical address in a memory; and a selection unit that, when one of the processors makes an memory access, obtains identification information of the processor and selects an address translation unit corresponding to an OS run by the processor identified by the identification information from among the address translation units as an address translation unit that performs address translation with respect to the memory access.

More specifically, each of the address translation units receives an access instruction outputted by the processor and translates a logical address specified in the access instruction into a physical address in a memory area of the memory, the memory area corresponding to an OS run by the processor.

More preferably, each address translation unit receives an instruction for access to a boot memory, the instruction being made by the processor, the boot memory storing boot programs for booting the OSs and translates a logical address specified in the access instruction into a physical address in the boot memory.

Preferably, the address translation units are each composed of programmable logic and a register.

The selection unit preferably includes a multiplexer that receives address signals representing addresses translated by the address translation units and selectively outputs one of the address signals to the memory; and a switch that changes the address signal to be outputted by the multiplexer in accordance with the identification information.

Another device is provided that controls memory accesses made by multiple processors. The device includes multiple address translation units that correspond to multiple OSs run by the processors and each receive an access instruction outputted by one of the processors, translate a logical address specified in the access instruction into a physical address in a memory area of a memory, the memory area corresponding to an OS run by the processor, receive an instruction for access to a boot memory, the instruction being made by the processor, the boot memory storing boot programs for booting the OSs, and translates a logical address specified in the access instruction into a physical address in the boot memory; and a selection unit that, when one of the processors outputs an access instruction, obtains identification information of the processor and selects an address translation unit corresponding to an OS run by the processor identified by the identification information from among the address translation units as an address translation unit that performs address translation with respect to the access instruction.

The present invention also provides a computer having multiple operating systems (OSs) installed therein. The computer includes multiple processors; a memory; and an address translation device that, when one of the processors makes a memory access, obtains identification information of the processor and translates the logical address of the destination of the memory access made by the processor into a physical address in a memory area of a memory, the memory area corresponding to an OS run by the processor identified by the identification information.

It is possible to virtualize a system without having to incorporate a special mechanism into software and with increases in overhead suppressed, by controlling memory accesses made by processors using hardware.

### BRIEF DESCRIPTION OF DRAWINGS

FIG. 1 is a diagram showing the concept of system virtualization according to an embodiment of the present invention.

FIG. 2 is a diagram showing an example hardware configuration of a virtualization system according to this embodiment.

FIG. 3 is a diagram showing a virtualization technique using a virtualization device according to this embodiment.

FIG. 4 is a diagram showing an example function configuration of the virtualization device according to this embodiment.

FIG. 5 shows the memory maps of OSs, the assignment of the memory space to a system memory in each OS, and the assignment of the boot area of a boot memory in each OS in an implementation example.

FIG. 6 is a diagram showing the configuration of the implementation example of the virtualization system according to this embodiment.

FIG. 7 shows a state in which settings are made for the virtualization device in the implementation example of the virtualization system shown in FIG. 6.

FIG. 8 is a diagram showing the concept of a host OS-type virtualization method.

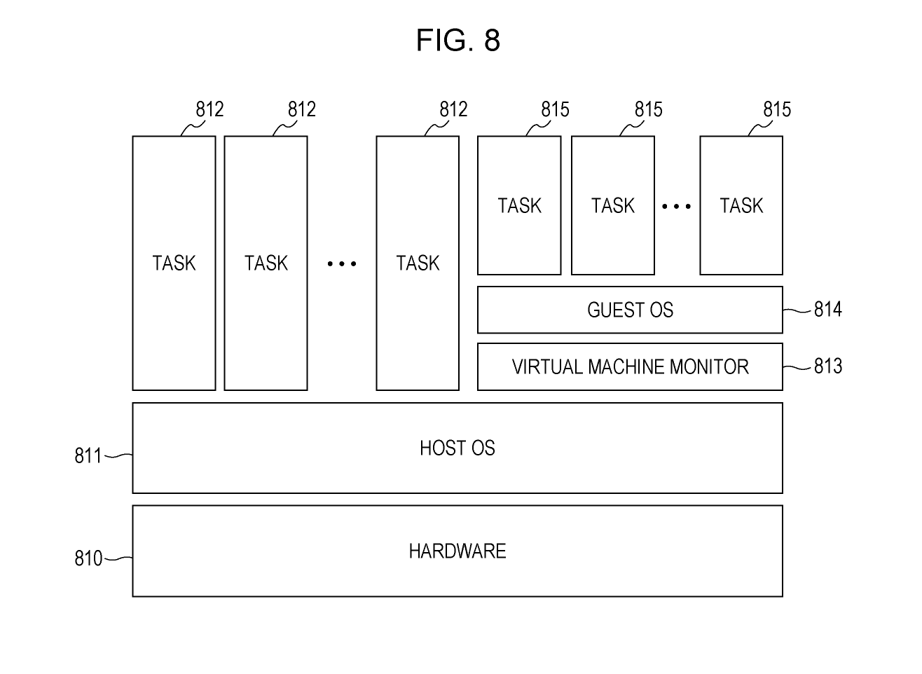

FIG. 9 is a diagram showing the concept of a hypervisor-type virtualization method.

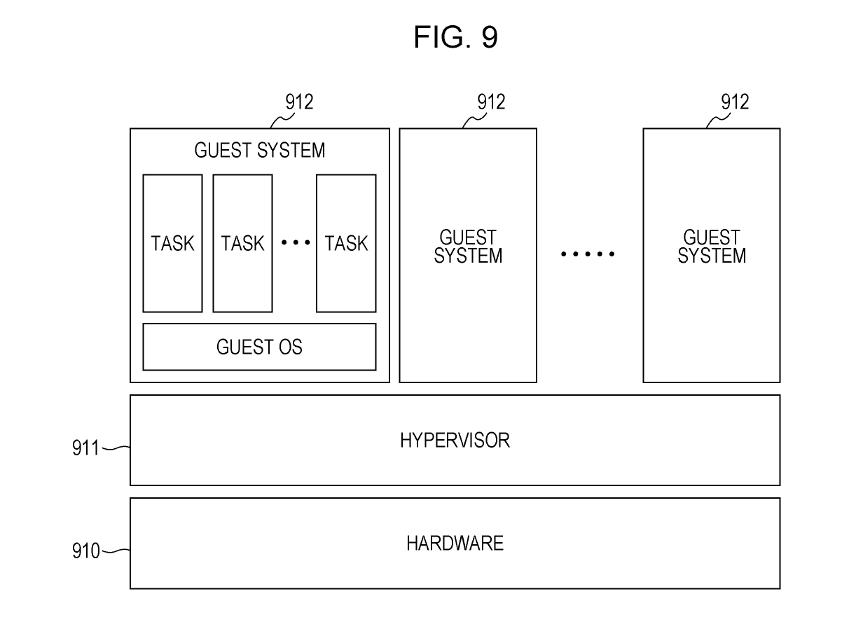

### DETAILED DESCRIPTION OF EMBODIMENTS

Hereafter, an embodiment of the present invention will be described in detail with reference to the accompanying drawings.

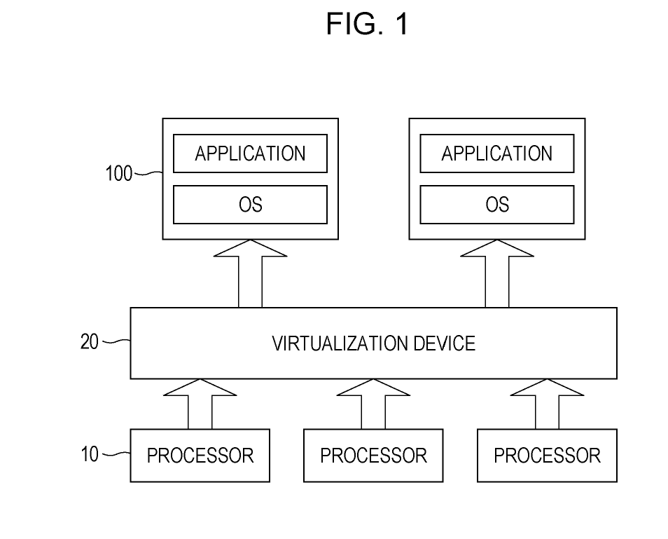

FIG. 1 is a diagram showing the concept of system virtualization according to this embodiment.

As shown in FIG. 1, a virtualization system according to this embodiment includes processors (processor cores) 10 and a virtualization device 20 as hardware. Sets of software (OS and application) 100 are run by the processors 10 through the virtualization device 20. That is, according to this embodiment, each OS directly runs on the hardware without through a hypervisor or host OS.

The virtualization device 20 mainly controls memory accesses made by the processors 10. That is, the virtualization device 20 provides different address spaces for the OSs. Under the control of the virtualization device 20, the OSs access the different address spaces while using the common physical memory. In this way, a virtual environment according to this embodiment is created. The configuration and functions of the virtualization device 20 will be described specifically later.

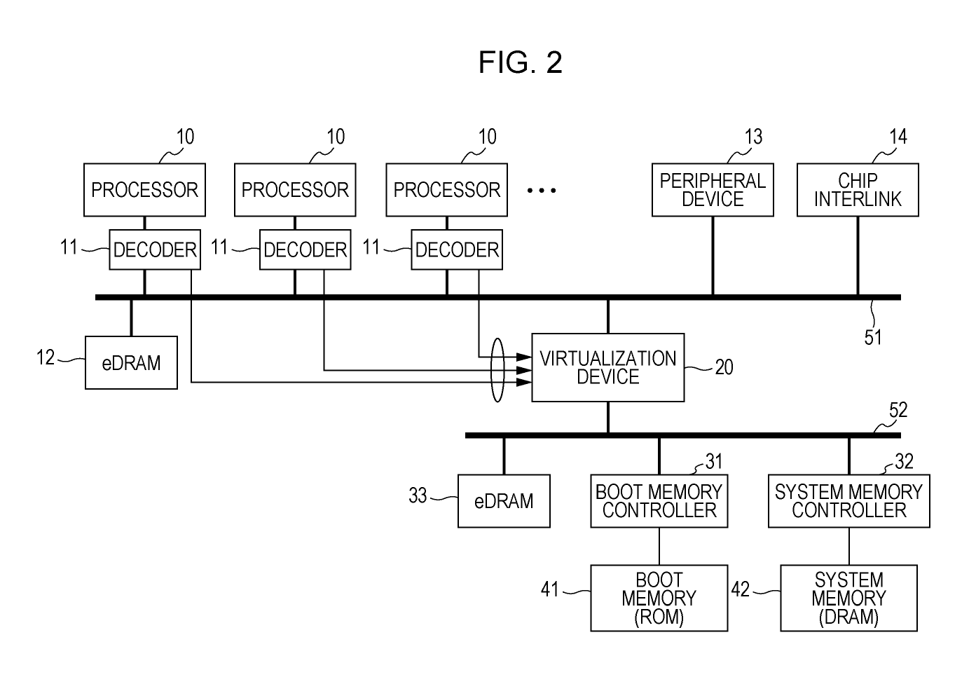

FIG. 2 is a diagram showing an example hardware configuration of the virtualization system according to this embodiment.

In FIG. 2, the virtualization device 20 is connected to a first local bus 51 and a second local bus 52. Connected to the first local bus 51 are the processors 10 and an eDRAM (Embedded DRAM) 12. Also connected to the first local bus 51 is a peripheral device (Peripheral Island Node) 13 and a chip interlink 14. While the multiple (unspecified number of) processors 10 are shown in FIG. 2, systems according to this embodiment may include one or more processors 10 or may include a multi-core processor including multiple processor cores.

Connected to the second local bus 52 is a boot memory controller 31 and a system memory controller 32. The boot memory controller 31 controls a read only memory (ROM) serving as a boot memory 41, while the system memory controller 32 controls a dynamic random access memory (DRAM) serving as a system memory 42. Also connected to the second local bus 52 is an eDRAM 33.

Since the system is configured as described above, the processors 10 and an external device (not shown) connected to the system through the peripheral device 13 and the chip interlink 14 access the boot memory 41 and the system memory 42 through the virtualization device 20.

As shown in FIG. 2, each processor 10 is connected to the first local bus 51 via a decoder 11. When a processor 10 makes a memory access through the virtualization device 20, a decoder 11 connected to the processor 10 sends to the virtualization device 20 unique information for identifying the processor 10 (processor ID or the like) and information for identifying the process (process ID or the like) as a control signal. According to this control signal, the virtualization device 20 identifies the processor 10 which is making the access. Depending on the type of the processor 10, the processor 10 itself may output information equivalent to a control signal. This eliminates the need to dispose the decoder 11, since the virtualization device 20 is only required to identify the processor 10 and the process in accordance with the information outputted by the processor 10.

The hardware shown in FIG. 2 may be formed on a single semiconductor chip. That is, the virtualization system according to this embodiment may be formed as an SoC (System on a Chip). Alternatively, rather than as an SoC, the virtualization system may be formed as a device having the individual components (processors 10, virtualization device 20, and the like) formed therein as different electronic circuits.

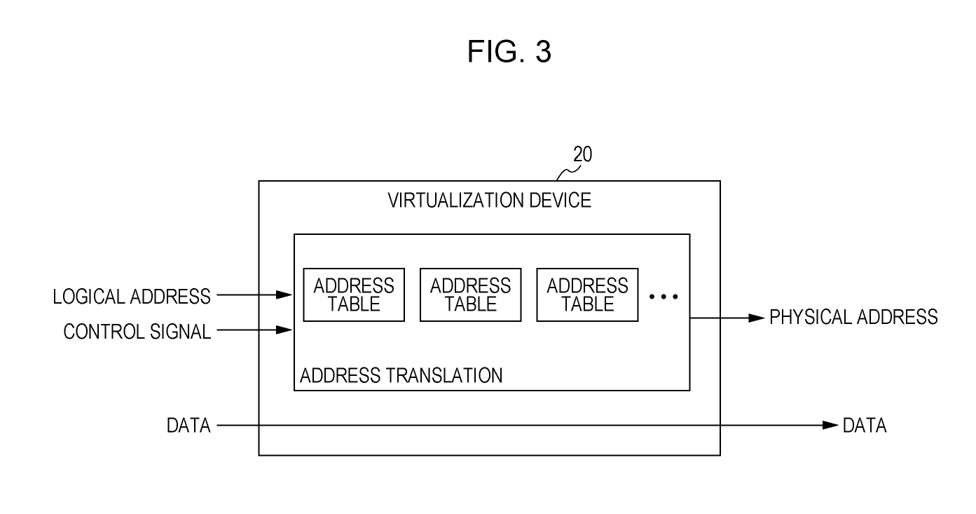

FIG. 3 is a diagram showing a virtualization technique using the virtualization device 20 according to this embodiment.

As shown in FIG. 3, when a processor 10 makes a memory access, the virtualization device 20 receives an access instruction containing a logical address (virtual address) indicating the access destination and a control signal. If the access is intended to write data, the virtualization device 20 also receives data to be written to the memory (boot memory 41 or system memory 42). The virtualization device 20 has multiple address translation tables corresponding to the OSs installed on the system. Using a table corresponding to an OS identified by the received control signal, the virtualization device 20 translates an access destination logical address contained in the access instruction into a physical address. The virtualization device 20 (address translation device) then sends the address-translated access instruction to the boot memory controller 31 or system memory controller 32.

As for the received data, the virtualization device 20 sends it to the boot memory controller 31 or system memory controller 32 as it is. If the access is intended to read data, the virtualization device 20 returns data read from the memory to the processor 10 as it is. Note that the virtualization device 20 may perform on the passing data a particular process having no effect on the access purpose. For example, in writing data to the memory, the virtualization device 20 may perform a process such as encryption or compression on the received data and then send the resulting data to the memory. On the other hand, when reading data from the memory, it may perform a process such as decryption or decompression on the read data and then send the resulting data to the processor 10.

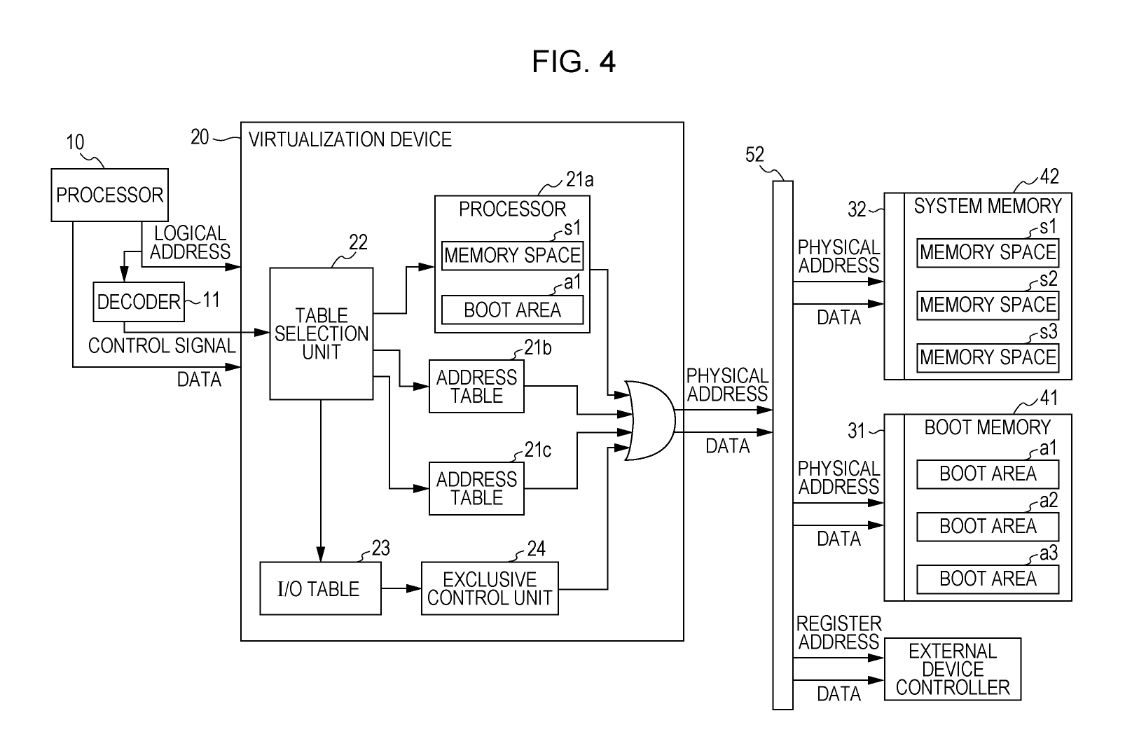

FIG. 4 is a diagram showing an example function configuration of the virtualization device 20.

As shown in FIG. 4, the virtualization device 20 includes multiple address tables 21, a table selection unit 22, an I/O table 23, and an exclusive control unit 24. The address tables 21 and the I/O table 23 are composed of, for example, programmable logic and a register and configured in accordance with the system configuration, including the types and number of the installed OSs and the capacities of the boot memory 41 and the system memory 42.

The address tables 21 are tables for performing translation using hardware (address translation units, translation units) and translate a logical address specified as the access destination in an access instruction from a processor 10 into an physical address in the memory (e.g., the system memory 42). As described above, the multiple address tables 21 corresponding to the OSs installed in the system are prepared. For example, three address tables 21 (21a, 21b, 21c) corresponding to three OSs are shown in the diagram. Settings for performing address translation related to access to the boot memory 41 and settings for performing address translation related to access to the system memory 42 are made in each address table 21.

In FIG. 4, for example, three boot areas (memory areas), a1, a2, and a3, corresponding to the multiple OSs are set in the boot memory 41. Each area is storing a boot program for booting the corresponding OS. For example, three memory spaces (memory areas), s1, s2, and s3, corresponding to the OSs are set in the system memory 42. Each memory space is an area used when the corresponding OS makes a memory access. Accordingly, assuming that the boot area a1 of the boot memory 41 and the memory space s1 of the system memory 42 correspond to a particular OS, OS 1, and that the address table 21a is prepared for the OS 1, the address table 21a is configured so that address translation of the boot area a1 and the memory space s1 is performed, as shown in FIG. 4.

When an OS makes a memory access, the table selection unit 22 selects an address table 21 corresponding to the OS in accordance with a control signal received from a processor 10 or decoder 11 corresponding to the OS. The access destination address in the memory access is translated in accordance with the address table 21 selected by the table selection unit 22.

The I/O table 23 manages an address assigned to the external device (input/output device). In this embodiment, MMIO (Memory-Mapped I/O) is used for input/output to the external device. That is, the address assigned to the external device is placed in the same address space as that of the memory. Since there is a need to manage the address assigned to the external device, the I/O table 23 is prepared. The number of addresses assigned to the external device may be one regardless of the OS. For this reason, in this embodiment, the single I/O table 23 is prepared unlike the address tables 21.

When one of the OSs is accessing the external device, the exclusive control unit 24 performs exclusive control so that the other OSs do not access the external device. As described above, in this embodiment, each OS uses the common I/O table 23 in order to access the external device. For this reason, exclusive control is performed so that multiple OSs do not access the same external device in an overlapped manner. Exclusive control related to input/output to the external device may be performed by a bus arbiter (not shown) disposed on the second local bus 52. In this case, the virtualization device 20 does not need to include the exclusive control unit 24.

Next, a specific implementation example according to this embodiment will be described.

First, the specification of this implementation example will be described specifically. The following system is considered in this implementation example.

Four 32-bit (4-gigabyte (GB) memory space) processors 10A to 10D are provided as processors 10.

The four-GB system memory 42 and the 756-kilobyte (KB) boot memory 41 are provided as the memory.

The boot memory controller 31 and the system memory controller 32 are addressed with 34 bits.

Three OSs, OS 1 to OS 3, are installed.

The OS 1 is run by processors 10A and 10B and uses the system memory 42 by 2 GB. The address table 21a is prepared for the OS 1.

The OS 2 is run by a processor 10C and uses the system memory 42 by 1 GB. The address table 21b is prepared for the OS 2.

The OS 3 is run by a processor 10D and uses the system memory 42 by 1 GB. The address table 21c is prepared for the OS 3.

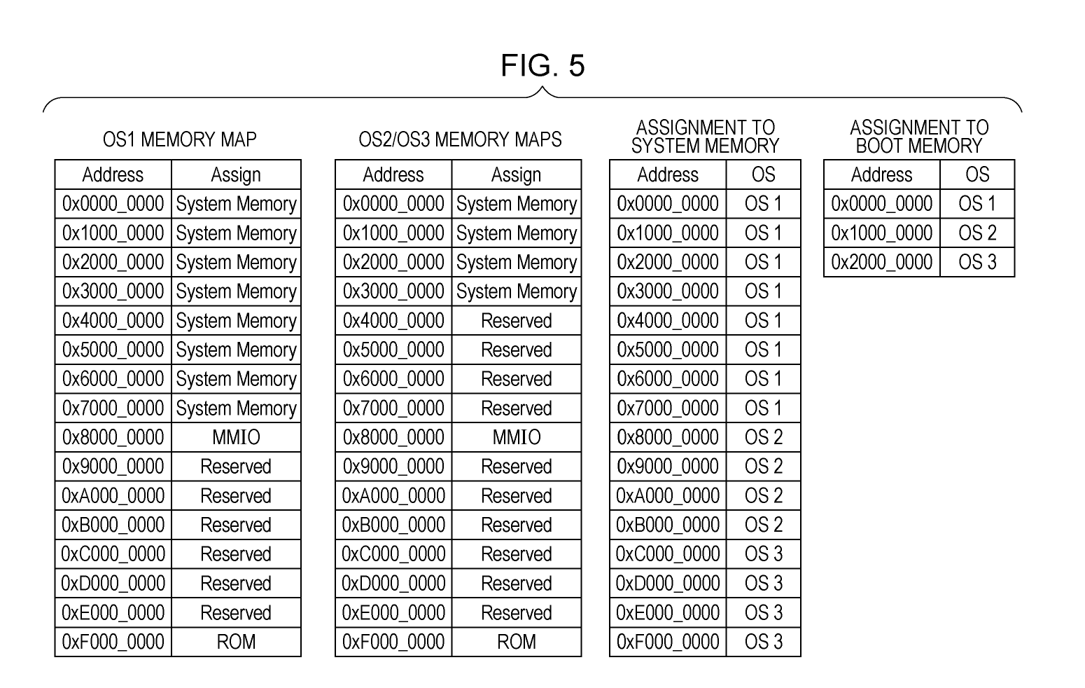

FIG. 5 shows the memory maps of the OSs, the assignment of the memory spaces of the system memory 42 to the OSs, and the assignment of the boot areas of the boot memory 41 to the OSs in this implementation example.

One cell represents a 256-KB area in the shown memory map and memory assignment table.

In the memory map of the OS 1 of FIG. 5, the memory space of the system memory 42 is assigned to the addresses 0x0000_{—}0000 to 0x7FFF_FFFF; MMIO is assigned to the addresses 0x8000_{—}0000 to 0x8FFF_FFFF; and the boot memory 41 is assigned to the addresses 0xF000_{—}0000 to 0xFFFF_FFFF.

Likewise, in the memory maps of the OS 2 and OS 3, the memory space of the system memory 42 is assigned to the addresses 0x0000_{—}0000 to 0x3FFF_FFFF; MMIO is assigned to the addresses 0x8000_{—}0000 to 0x8FFF_FFFF; and the boot memory 41 is assigned to the addresses 0xF000_{—}0000 to 0xFFFF_FFFF.

In the assignment of the memory space of the system memory 42, the memory space of the OS 1 is assigned to the addresses 0x0000_{—}0000 to 0x7FFF_FFFF; the memory space of the OS 2 is assigned to the addresses 0x8000_{—}0000 to 0xBFFF_FFFF; and the memory space of the OS 3 is assigned to the addresses 0xC000_{—}0000 to 0xFFFF_FFFF.

In the assignment of the boot area to the boot memory 41, the boot area of the OS 1 is assigned to the addresses 0x0000_{—}0000 to 0x0FFF_FFFF; the boot area of the OS 2 is assigned to the addresses 0x1000_{—}0000 to 0x1FFF_FFFF; and the boot area of the OS 3 is assigned to the addresses 0x2000_{—}0000 to 0x2FFF_FFFF.

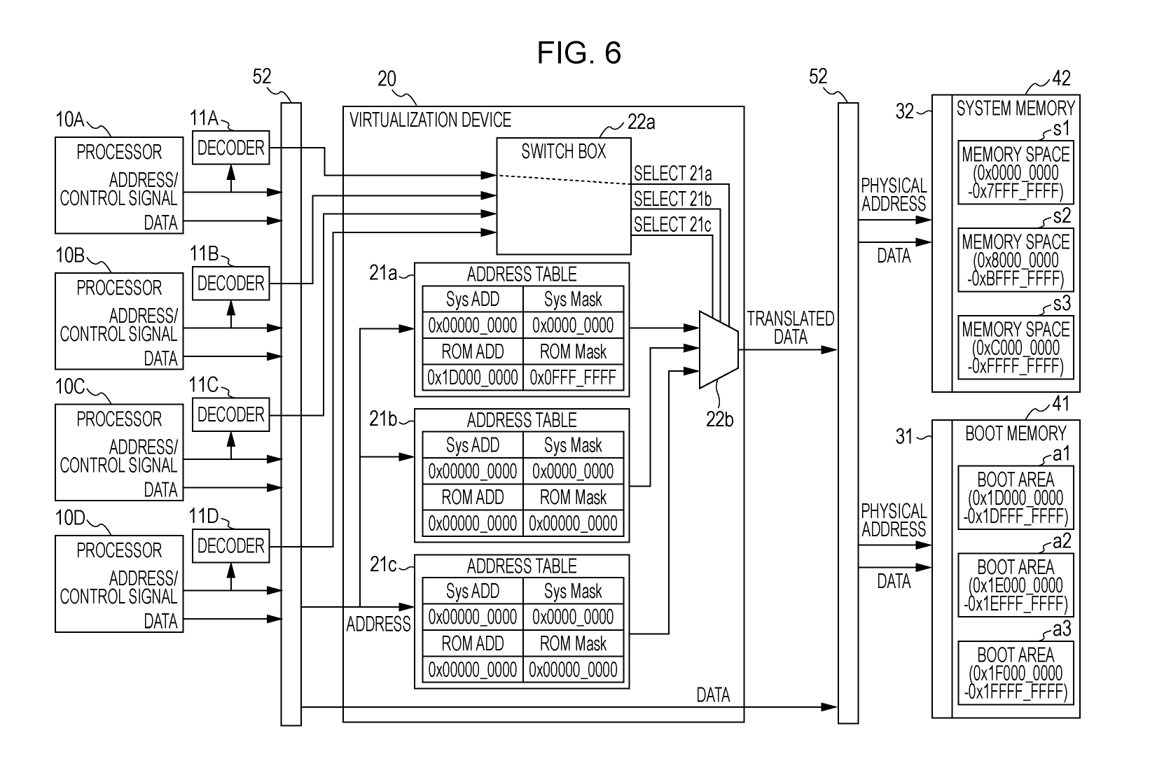

FIG. 6 is a diagram showing the configuration of the implementation example of the virtualization system according to this embodiment.

In the implementation example shown in FIG. 6, a switch box 22a and a multiplexer 22b are disposed as the table selection unit 22. The multiplexer 22b receives address signals (signals representing translated addresses) outputted from the address tables 21 and outputs one of the signals. Upon receipt of a control signal from a decoder 11, the switch box 22a controls the multiplexer 22b so that the multiplexer 22b outputs an address signal outputted from a address table 21 corresponding to a processor 10 specified in the control signal. In this implementation example, the processors 10 use an IP block control bus (not shown) in order to configure the switch box 22a and the address tables 21.

Further, in this implementation example, exclusive control related to input/output to the external device is performed by the bus arbiter disposed on the second local bus 52. Accordingly, the virtualization device 20 does not include the exclusive control unit 24.

In this implementation example, the processors 10A and 10B are configured as symmetric multiple processors (SMPs), run by the same OS, the OS 1, and commonly use the address table 21a for address translation. The processor 10C is run by the OS 2 and uses the address table 21b for address translation. The processor 10D is run by the OS 3 and uses the address table 21c for address translation. In the example shown in FIG. 6, the processors 10A to 10D are provided with decoders 11A to 11D, respectively. Note that if the processors 10A to 10D themselves output a control signal, the decoders 11A to 11D are not needed.

The boot memory 41 includes a boot area a1 (0x1D000_{—}0000-0x1DFFF_FFFF) for the OS 1, a boot area a2 (0x1E000_{—}0000-0x1EFFF_FFFF) for the OS 2, and a boot area a3 (0x1F000_{—}0000-0x1FFFF_FFFF) for the OS 3. In FIG. 6, the addresses of the boot areas a1, a2, and a3 of the boot memory 41 are represented by 34-bit system address space.

The system memory 42 includes a memory space s1 (0x0000_{—}0000-0x7FFF_FFFF) for the OS 1, a memory space s2 (0x8000_{—}0000-0xBFFF_FFFF) for the OS 2, and a memory space s3 (0xC000_{—}0000-0xFFFF_FFFF) for the OS 3.

FIG. 6 shows the initial state of the system thus configured (a state where settings for virtualization are not made for any of the switch box 22a included in the table selection unit 22 and the address tables 21a to 21c). In this initial state, the virtualization device 20 of this system is configured so that the processor 10A accesses the corresponding boot area of the boot memory 41, reads a boot program, and executes it.

In FIG. 6, the switch box 22a is configured to select the address table 21a in accordance with a control signal from the decoder 11A of the processor 10A. (See a broken line in the diagram) Addresses (“ROM ADD” and “ROM Mask”) of the boot area a1 of the boot memory 41 are set in the address table 21a. No other settings are made: no other settings are made for the switch box 22a; addresses (“Sys ADD” and “Sys Mask”) of the memory space s1 of the system memory 42 are not set in the address table 21a; and no settings are made for the address table 21bs and 21c.

When the reset of the processor 10A is released by power-on or the like in this state, the switch box 22a controls the multiplexer 22b in accordance with a control signal from the decoder 11A, thereby selecting the address table 21a. According to the setting of the address table 21a, the processor 10A accesses the boot area a1 of the boot memory 41 to execute a boot program. Due to the execution of this boot program, settings are made for the switch box 22a; settings about the memory space s1 corresponding to the processor 10A of the system memory 42 are made for the address table 21a; and settings about other processors, 10B and 10C, are made.

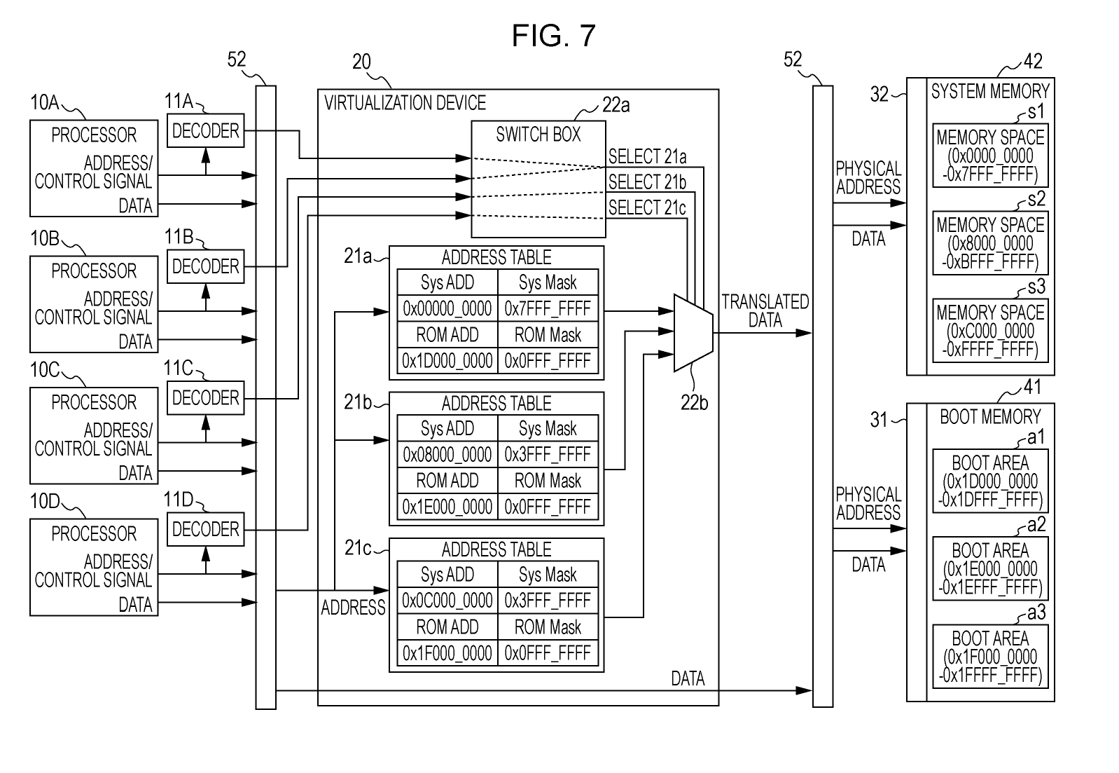

FIG. 7 shows a state in which the above-mentioned settings are made in the implementation example of the virtualization system shown in FIG. 6.

Specifically, first, the switch box 22a is configured to select the address table 21a in accordance with a control signal from the decoder 11A, select the address table 21a in accordance with a control signal from the decoder 11B, select the address table 21b in accordance with a control signal from the decoder 11C, and select the address table 21c in accordance with a control signal from the decoder 11D. (See Broken Lines in the Diagram.)

Further, based on the memory map of the OS 1 shown in FIG. 5, the addresses 0x0000_{—}0000 to 0x7FFF_FFFF of the memory space s1 of the system memory 42 are set in the address table 21a. For example, the start address (“Sys ADD”) and mask data for setting the data range (“Sys Mask”) are set as shown in FIG. 7. The address can be translated by obtaining AND of an address (logical address) contained in the access instruction outputted by the processor 10A, and the start address and the mask data.

Further, addresses in the boot area a2 of the boot memory 41 and addresses in the memory space s2 of the system memory 42 are set in the address table 21b for the OS 2. Likewise, addresses in the boot area a3 of the boot memory 41 and addresses in the memory space s3 of the system memory 42 are set in the address table 21c for the OS 3.

Due to the above-mentioned settings, the processor 10A can use the system memory 42. For example, by copying the boot program to the system memory 42, the processor 10A boots the OS 1.

Next, the reset of the processor 10B is released. Since the processors 10A and 10B are SMPs in this implementation example as described above, the processor 10B uses the same address table, 21a, as the processor 10A does.

Next, the reset of the processor 10C is released. The addresses in the boot area a2 of the boot memory 41 and the addresses in the memory space s2 of the system memory 42 have already been set in the address table 21b for the OS 2 run by the processor 10C. Accordingly, the processor 10C routinely boots the OS 2.

Further, the reset of the processor 10D is released. The addresses in the boot area a3 of the boot memory 41 and the addresses in the memory space s3 of the system memory 42 have already been set in the address table 21c for the OS 3 run by the processor 10D. Accordingly, the processor 10D routinely boots the OS 3.

In the above-mentioned example, the reset of the processor 10A is first released and the settings are then made for the switch box 22a and the address tables 21a, 21b, and 21c, thereby starting the entire virtualization system. Note that the processor that is first released from the reset can be previously determined using a hardware setting (FIG. 6) and is not limited to a particular processor, the processor 10. Further, the setting operation at start is not limited to the procedure of the above-mentioned implementation example, as long as each processor 10 can access the corresponding area of the memory (boot memory 41 and system memory 42) and the OSs run by the processors 10 can boot while using the system memory 42.

As described above, when an installed OS makes an access, the virtualization device 20 according to this embodiment performs address translation (logical address-to-physical address translation) so that a memory area previously assigned to the OS is used. Accordingly, each OS can run in a virtual environment provided by this embodiment without having to be designed or modified so as to be usable in a virtualization system.

Further, in this embodiment, the virtualization device 20 performs address translation when a memory access is made. This eliminates a need for a mechanism which creates a virtual environment using software such as a host OS or hypervisor. Thus, the loads imposed on the processors can be reduced.

While this embodiment has been described, the technical scope is not limited to the above-mentioned embodiment. It is apparent from the appended claims that various changes and modifications made to the above-mentioned embodiment can fall within the technical scope of the invention.

1. A device that controls memory accesses made by a plurality of processors, the device comprising:
a plurality of address translation units that correspond to a plurality of operating systems (OSs) run by the processors and that each translate the logical address of the destination of a memory access made by a corresponding processor into a physical address in a memory; and
a selection unit that, when one of the processors makes a memory access, obtains identification information of the processor and selects an address translation unit corresponding to an OS run by the processor identified by the identification information from among the address translation units as an address translation unit that performs address translation with respect to the memory access.

2. The device according to claim 1, wherein each of the address translation units receives an access instruction outputted by the corresponding processor and translates a logical address specified in the access instruction into a physical address in a memory area of the memory, the memory area corresponding to an OS run by the processor.

3. The device according to claim 2, wherein
each of the address translation units receives an instruction for access to a boot memory, the instruction being made by the corresponding processor, the boot memory storing boot programs for booting the OSs and translates a logical address specified in the access instruction into a physical address in the boot memory.

4. The device according to claim 1, wherein
the address translation units are each composed of programmable logic and a register.

5. The device according to claim 1, wherein
the selection unit comprises:
a multiplexer that receives address signals representing addresses translated by the address translation units and selectively outputs one of the address signals to the memory; and
a switch that changes the address signal to be outputted by the multiplexer in accordance with the identification information.

6. A device that controls memory accesses made by a plurality of processors, the device comprising:
a plurality of address translation units that correspond to a plurality of operating systems (OSs) run by the processors and that each receive an access instruction outputted by a corresponding processor, translate a logical address specified in the access instruction into a physical address in a memory area of a memory, the memory area corresponding to an OS run by the processor, receive an instruction for access to a boot memory, the instruction being made by the corresponding processor, the boot memory storing boot programs for booting the OSs, and translate a logical address specified in the access instruction into a physical address in the boot memory; and
a selection unit that, when one of the processors makes a memory access, obtains identification information of the processor and selects an address translation unit corresponding to an OS run by the processor identified by the identification information from among the address translation units as an address translation unit that performs address translation with respect to the access instruction.

7. A computer having a plurality of operating systems (OSs) installed therein, the computer comprising:
a plurality of processors;
a memory; and
an address translation device that, when one of the processors makes a memory access, obtains identification information of the processor and translates the logical address of the destination of the memory access made by the processor into a physical address in a memory area of the memory, the memory area corresponding to an OS run by the processor identified by the identification information.

8. The computer according to claim 7, wherein
the address translation device comprises:
a plurality of translation units that correspond to the OSs and that each receive an access instruction outputted by a corresponding processor and translate a logical address specified in the access instruction into a physical address in a memory area of the memory, the memory area corresponding to an OS run by the processor; and
a selection unit that obtains the identification information and selects a translation unit corresponding to an OS run by the processor identified by the identification information from among the translation units as a translation unit that performs address translation with respect to the memory access.

9. The computer according to claim 8, further comprising
a boot memory storing boot programs for booting the OSs, wherein
the address translation device receives an instruction for access to the boot memory, the instruction being made by the corresponding processor, and translates a logical address specified in the access instruction into a physical address in the boot memory.
